(19) United States
(12) Patent Application Publication
(10) Pub. No.: US 2024/0004941 A1
(43) Pub. Date: Jan. 4, 2024

(54) USER PREFERENCE QUERY METHOD, DEVICE, STORAGE MEDIUM, AND TERMINAL OF CLOUD PLATFORM

(71) Applicant: PATEO CONNECT+ Technology (Shanghai) Corporation, Shanghai (CN)

(72) Inventors: Tao GUO, Shanghai (CN); Lei LIU, Shanghai (CN)

(21) Appl. No.: 18/467,938

(22) Filed: Sep. 15, 2023

Related U.S. Application Data
(63) Continuation of application No. PCT/CN2021/103298, filed on Jun. 29, 2021.

(30) Foreign Application Priority Data
Mar. 17, 2021 (CN) 202110287679.7

(51) Int. Cl. G06F 16/9535; G06F 16/9538; H04W 4/44

(52) U.S. Cl. CPC G06F 16/9535; G06F 16/9538; H04W 4/44

(57) ABSTRACT

A user preference data accessing and calling method of a cloud platform includes generating or updating user preference information, setting an smart query interface, and after the smart query interface obtains a user query request from a terminal, returning a query result according to the user preference information.

### CROSS-REFERENCE TO RELATED APPLICATION

This application is a continuation of International Application No. PCT/CN2021/103298, filed Jun. 29, 2021, which claims priority to Chinese Patent Application No. 202110287679.7, filed on Mar. 17, 2021, the entire contents of both of which are incorporated herein by reference.

### TECHNICAL FIELD

The present disclosure relates to the vehicle smart control technology field and, more particularly, to a user preference query method, device, storage medium, and terminal of a cloud platform.

### BACKGROUND

With the rapid development of technology, vehicles are widely used and are essential for traveling. Thus, a vehicle information terminal device related to the vehicles has been also developed to bring convenience to people. The vehicle information terminal device is also referred to as an in-vehicle device. The in-vehicle device is configured to provide safety services including position information, productivity improvement services of an office environment, and other personalized services such as finance, reservations, and product purchases. In addition, typical services provided by the in-vehicle device include fields in a navigation function, traffic information, an emergency structure, and fields related to various entertainment performances. Moreover, the in-vehicle device can store personal information such as a voice recording, an address book, etc.

However, as user demand increases, the function of the in-vehicle device becomes more and more complex, which makes the in-vehicle device more and more complicated and difficult for the user to use. The existing in-vehicle device has the disadvantages of cumbersome operation and slow query speed.

### SUMMARY

Embodiments of the present disclosure provide a user preference data accessing and calling method of a cloud platform. The method includes generating or updating user preference information, setting an smart query interface, and after the smart query interface obtains a user query request from a terminal, returning a query result according to the user preference information.

Embodiments of the present disclosure provide a user preference data accessing and calling server of a cloud platform, including an information processing module, an interface setting module, and an smart query module. The information processing module is configured to generate or update user preference information. The interface setting module is configured to set an smart query interface. The smart query module is configured to, after the smart query interface obtains a user query request from a terminal, return a query result according to the user preference information generated or updated by the information processing module.

Embodiments of the present disclosure provide a non-transitory computer-readable storage medium storing computer instructions that, when executed by a processor, cause the processor to generate or update user preference information, set an smart query interface, and after the smart query interface obtains a user query request from a terminal, return a query result according to the user preference information.

Compared with the existing technology, the technical solution of the present disclosure has the following beneficial effects.

In the method of the technical solution of the present disclosure, the cloud platform can generate or update the user preference information. The cloud platform can set the smart query interface. The smart query interface can return the query result according to the user preference information after obtaining the user query request from the terminal. When obtaining the user query request, the smart query interface can call the user preference information, query the Internet or cloud platform database, and return the query result to the terminal. On one hand, for the user query request, only one smart query interface can be called to perform the query. Thus, a query process of performing the user query request by the terminal can be simplified. On another hand, the query result can be optimized according to the user preference information to cause the query result to be more suitable for a user preference.

Further, the user information can also include the user masking identity. Thus, the smart interface can adapt to preferences of different users to realize customization of the user.

In the server of the technical solution of the present disclosure, the information processing module can be configured to generate or update the user preference information. The interface setting module can be configured to set the smart query interface. The smart query module can be configured to obtain the user query request from the terminal and return the query result according to the user preference information generated or updated by the information processing module. When obtaining the user query request, the smart query interface can call the user preference information, query the Internet or the database, and return the query result to the terminal. On one hand, for the user query request, only one smart query interface can be called to perform the query. Thus, a query process of performing the user query request by the terminal can be simplified. On another hand, the query result can be optimized according to the user preference information to cause the query result to be more suitable for a user preference.

### BRIEF DESCRIPTION OF THE DRAWINGS

FIG. 1 is a schematic flowchart of a user preference data accessing and calling method of a cloud platform according to some embodiments of the present disclosure.

FIG. 2 is a schematic flowchart of a user preference information generation or updating method according to some embodiments of the present disclosure.

FIG. 3 is a schematic flowchart showing steps of returning a query result by an smart query interface according to user preference information after obtaining a user query request from a terminal according to some embodiments of the present disclosure.

FIG. 4 is a schematic flowchart showing steps of returning a query result by an smart query interface according to user preference information after obtaining a user query request from a terminal according to some other embodiments of the present disclosure.

FIGS. 5 to 8 are schematic structural diagrams of a user preference data accessing and calling server of a cloud platform according to some embodiments of the present disclosure.

### DETAILED DESCRIPTION OF EMBODIMENTS

As mentioned in the background, user experience of an existing in-vehicle device still needs to be improved.

In some embodiments, when a user performs a query operation on an in-vehicle terminal, the in-vehicle terminal can be connected to a cloud platform. The cloud platform can return a query result to the in-vehicle terminal according to a user query category. The cloud platform can have different interfaces according to different service divisions. Request parameters and response parameters of each interface can be different. Thus, as the cloud platform service becomes more and more complex, a number of interfaces that the in-vehicle terminal needs to call increase sharply, which make the in-vehicle terminal more and more complicated to use.

To solve the above problem, the present disclosure provides a user preference query method, device, storage medium, and terminal of a cloud platform. The cloud platform can generate or update user preference information. An smart query interface can be arranged for the cloud platform. The smart query interface can be configured to return a query result according to the user preference information after obtaining a user query request from the terminal. When obtaining the user query request, the smart query interface can call the user preference information, perform a query on Internet or a cloud platform database, and return the query result to the terminal. On one hand, for the user query request, only one smart query interface can be called to perform the query. Thus, a query process of performing the user query request by the terminal can be simplified. On another hand, the query result can be optimized according to the user preference information to cause the query result to be more suitable for a user preference.

To make the above objects, features, and beneficial effects of the present disclosure more comprehensible, specific embodiments of the present disclosure are described in detail below in connection with the accompanying drawings.

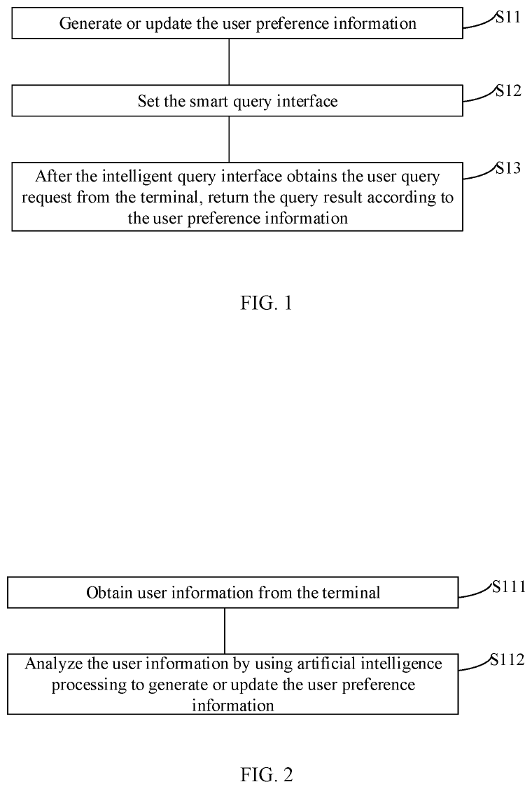

FIG. 1 is a schematic flowchart of a user preference data accessing and calling method of a cloud platform according to some embodiments of the present disclosure.

With reference to FIG. 1, the user preference data accessing and calling method of the cloud platform includes the following processes.

At S11, the user preference information is generated or updated.

At S12, the smart query interface is set.

At S13, after obtaining the user query request from the terminal, the smart query interface returns the query result according to the user preference information.

Then, the processes of the user preference data accessing and calling method of the cloud platform are analyzed and explained.

In process S11, the user preference information is generated and updated.

FIG. 2 is a schematic flowchart of a user preference information generation or updating method according to some embodiments of the present disclosure.

Referring to FIG. 2, the user preference information generation or updating method includes obtaining user information from the terminal (S111) and analyzing the user information by using artificial intelligence processing to generate or update the user preference information (S112).

In process S111, obtaining the user information from the terminal can include the following processes.

Obtaining the user information from the terminal can include establishing an upload connection channel with the terminal and obtaining the user information from the terminal through the upload connection channel.

In some embodiments, the terminal can include an in-vehicle terminal. The in-vehicle terminal can be configured to collect the user information and upload the user information to the cloud platform through the upload connection channel.

The user information can include user operation information, user feedback information, and terminal current state information.

The user operation information can include voice information, voice-to-text information, input text information, or touch information. The voice information can include the content of voice interaction between the user and the in-vehicle terminal and information of performing an operation according to the voice information. The voice-to-text information can include the content of the in-vehicle terminal converting a voice input by the user into text and information of sending the text to an application. The input text information can include the content of the text input by the user on the in-vehicle terminal. The touch information can include user touch operation information on the application of the in-vehicle terminal.

The current state information of the terminal can include network environment, application, current position, temperature, humidity, driving status, or speed. The network environment can include a network currently connected to the in-vehicle terminal, including a 4G network, WIFI network, or no network connection. The application can be an application opened by the in-vehicle terminal when collecting the user operation information. The current position can be position information collected by a GPS device of the in-vehicle terminal. The temperature can be temperature inside and outside the vehicle collected by a thermometer of the in-vehicle terminal. The humidity can be humidity inside and outside the vehicle collected by a hygrometer of the in-vehicle terminal. The driving status can be whether the current vehicle is driving or parked. The speed can be whether the current vehicle speed is high speed or low speed.

The user feedback information can include smart interface calling information and smart interface calling frequency information. The smart interface calling information can be whether the smart interface is effectively used. The smart interface calling frequency information can be whether the smart interface is called repeatedly.

In some embodiments, the user information can further include a user masking identity. The user masking identity can be information that can be used to identify user identity but does not involve user privacy, for example, gender. User timbre can be identified through voiceprint, and different users can be distinguished through face recognition technology.

The user information can also include the user masking identity. Thus, the in-vehicle terminal can obtain user preference information of different users. As such, the smart interface can be displayed differently for different users to realize customization for the user.

Analyzing the user information by using the artificial intelligence processing to generate the user preference information can include analyzing the obtained user information to obtain an initial parameter and generating the user preference information with the initial parameter.

Analyzing the user information by using the artificial intelligence processing to update the user preference information can include analyzing the obtained user information to obtain an update parameter and adding the update parameter to the user preference information to update the user preference information.

Analyzing the user information by using the artificial intelligence processing can include obtaining the user preference information corresponding to a plurality of users by the artificial intelligence processing through machine learning. After a plurality of times of machine learning, the obtained user preference information can become more and more accurate, and the cloud platform can be more and more smart.

The user preference information can include association information between user operations and the current state of the terminal. For example, when the vehicle is driving at a high speed, the user can be in favor of certain music or a certain radio station. When the vehicle is parked, the user can be in favor of certain music, certain news, a certain radio station, or a certain type of video. The user can have a favorite temperature and humidity in the vehicle. The user can have a favorite celebrity, and music, videos, and news related to the celebrity.

In some embodiments, the user preference information can further include personal preference information and similar user preference information. The personal preference information can be personal preference information of the user. The similar user preference information can be preference information of a certain type of user after big data processing, such as female user preferences, male user preferences, or user preferences of different age groups.

Arranging the smart query interface is described below.

When obtaining the user query request, the smart query interface can call the user preference information, perform the query on Internet or the database, and return the query result to the terminal.

The smart query interface can be an integrated interface abstracted from a plurality of resource services. The terminal can only need to call one smart query interface to query and use the plurality of resource services.

In some embodiments, the smart query interface can correspond to content-type services, such as news, music, radio, video, etc.

After the smart query interface obtains the user query request from the terminal, returning the query result according to the user preference information is described in detail below.

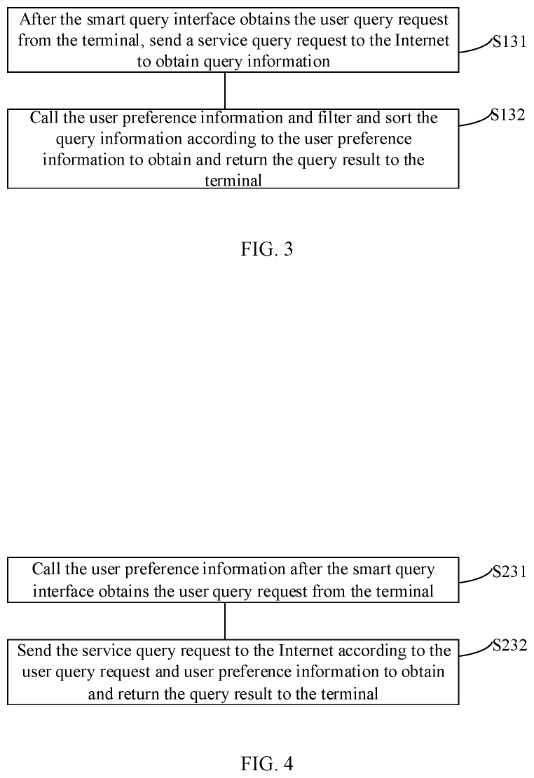

FIG. 3 is a schematic flowchart showing steps of returning the query result by the smart query interface according to the user preference information after obtaining the user query request from the terminal according to some embodiments of the present disclosure.

Please refer to FIG. 3, in some embodiments, after the smart query interface obtains the user query request from the terminal, returning the query result according to the user preference information includes the following processes.

At S131, after obtaining the user query request from the terminal, the smart query interface sends a service query request to the Internet to obtain query information.

At S132, the user preference information is called, the query information is filtered and sorted according to the user preference information to obtain and return the query result to the terminal.

After obtaining the user query request from the terminal, the smart query interface sending the service query request to the Internet to obtain the query information can include the following processes.

The smart query interface can obtain the user query request from the terminal. The content of the user query request can include music, news, radio, video, etc. A plurality of types of user query requests can only need to call one smart query interface to perform the query, which simplifies the terminal query process for performing the service query request.

The smart query interface can send the service query request to the Internet according to the user query request. The Internet can return the query information according to the service query request.

Calling the user preference information and filtering and sorting the query information according to the user preference information to obtain and return the query result to the terminal is described below.

Filtering and sorting the query information according to the user preference information can include removing the content of the returned query information that the user does not like and sorting the contents that the user likes. For example, the returned query information can include a variety of songs. The songs of the musicians that the user likes can be sorted in front. The returned query information can include a variety of news, such as current news and entertainment news, etc. The types most frequently browsed by the user can be sorted in front.

In some other embodiments, after the smart query interface obtains the user query request from the terminal, the service query request can be sent to the database of the cloud platform.

After the smart query interface obtains the user query request from the terminal, returning the query result according to user preference information can include, sending the service query request to the database to obtain the query information, calling the user preference information, filtering and sorting the query information according to the user preference information, and obtaining and returning the query result to the terminal.

A plurality of databases can be included. The smart query interface can send the service query request to one of the databases. The database can be a database including a content service, such as news, music, radio, video, etc.

When obtaining the user query request, the smart query interface can first query the Internet or the database to obtain the query information, then call the user preference information to filter and sort the query information, and obtain and return the query results to the terminal. On the one hand, for the user service query request, only one smart query interface can need to be called to perform the query. Thus, the query process of the terminal performing the service query request can be simplified. On another hand, the query result can be optimized according to the user preference information to cause the query result to be more suitable for the user preference.

FIG. 4 is a schematic flowchart showing steps of returning the query result by the smart query interface according to the user preference information after obtaining the user query request from the terminal according to some other embodiments of the present disclosure.

With reference to FIG. 4, in some embodiments, after the smart query interface obtains the user query request from the terminal, returning the query result according to the user preference information includes the following processes.

At S231, the smart query interface calls the user preference information after obtaining the user query request from the terminal.

At S232, the service query request is sent to the Internet according to the user query request and user preference information to obtain and return the query result to the terminal.

In some embodiments, the smart query interface can send the user query request and the user preference information to the Internet to perform the query. The query result returned by the Internet can be the query result after filtering and sorting.

In some other embodiments, the smart query interface can send the service query request to the database of the cloud platform according to the user query request and user preference information.

After the smart query interface obtains the user query request from the terminal, returning the query result according to the user preference information can include, after the smart query interface obtains the user query request from the terminal, calling the user preference information, and, according to the user query request and the user preference, sending the service query request to the database to obtain and return the query result to the terminal.

A plurality of databases can be included. The smart query interface can send the service query request to one of the databases. The database can be a database including the content services, such as news, music, radio, video, etc.

The smart query interface can send the user query request and user preference information to the database to perform the query. The query result returned by the Internet can be the query result after filtering and sorting.

When obtaining the user query request, the smart query interface can first call the user preference information, and then send the service query request to the Internet or the database according to the user query request and the user preference information to obtain and return the query result to the terminal. On one hand, the user service query request can only need to call one smart query interface to perform the query, which simplifies the query process of the terminal performing the service query request. On another hand, when sending the service query request to the Internet or the database, the query result can be optimized according to the user preference information to cause the query result to be more suitable with the user preference.

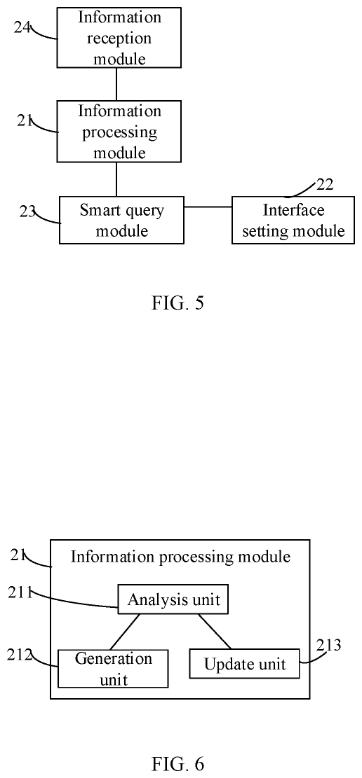

FIGS. 5 to 8 are schematic structural diagrams of a user preference data accessing and calling server of the cloud platform according to some embodiments of the present disclosure.

Please refer to FIG. 5, the user preference data accessing and calling server of the cloud platform includes an information processing module 21 configured to generate or update the user preference information, an interface setting module 22 configured to set the smart query interface, and an smart query module 23 configured to, after the smart query interface obtains the user query request from the terminal, generate or update the user preference information according to the information processing module to return the query result.

In some embodiments, the user preference data accessing and calling server of the cloud platform further includes an information reception module 24 configured to obtain the user information from the terminal.

FIG. 8 is a schematic structural diagram of the information reception module 24. The information reception module 24 includes a connection unit 241 configured to establish the upload connection channel with the terminal and an acquisition unit 242 configured to obtain the user information from the terminal through the upload connection channel.

In some embodiments, the terminal can include the in-vehicle terminal. The in-vehicle terminal can be configured to collect the user information and upload the user information to the cloud platform through the upload connection channel.

The user information can include user operation information, user feedback information, and terminal current state information.

The user operation information can include voice information, voice-to-text information, input text information, or touch information. The voice information can include the content of voice interaction between the user and the in-vehicle terminal and information of performing an operation according to the voice information. The voice-to-text information can include the content of the in-vehicle terminal converting a voice input by the user into text and information of sending the text to an application. The input text information can include the content of the text input by the user on the in-vehicle terminal. The touch information can include user touch operation information on the application of the in-vehicle terminal.

The current state information of the terminal can include network environment, application, current position, temperature, humidity, driving status, or speed. The network environment can include a network currently connected to the in-vehicle terminal, including a 4G network, WIFI network, or no network connection. The application can be an application opened by the in-vehicle terminal when collecting the user operation information. The current position can be position information collected by a GPS device of the in-vehicle terminal. The temperature can be temperatures inside and outside the vehicle collected by a thermometer of the in-vehicle terminal. The humidity can be humidity inside and outside the vehicle collected by a hygrometer of the in-vehicle terminal. The driving status can be whether the current vehicle is driving or parked. The speed can be whether the current vehicle speed is high speed or low speed.

The user feedback information can include smart interface calling information and smart interface calling frequency information. The smart interface calling information can be whether the smart interface is effectively used. The smart interface calling frequency information can be whether the smart interface is called repeatedly.

In some embodiments, the user information can further include a user masking identity. The user masking identity can be information that can be used to identify user identity but does not involve user privacy, for example, gender. User timbre can be identified through voiceprint, and different users can be distinguished through face recognition technology.

The user information can also include the user masking identity. Thus, the in-vehicle terminal can obtain user preference information of different users. As such, the smart interface can be displayed differently for different users to realize customization for the user.

In some embodiments, the terminal can include a user state collection module. The user state collection module can be configured to collect the user operation information and the terminal current state information.

FIG. 6 is a schematic structural diagram of the information processing module 21. The information processing module 21 includes an analysis unit 211 configured to analyze the obtained user information to obtain the initial parameter and a generation unit 212 configured to generate the user preference information with the initial parameter.

The analysis unit 211 can be also configured to analyze the obtained user information to obtain the update parameter. The information processing module 21 also includes an update unit 213 configured to add the update parameter into the to-be-updated user preference information to update the user preference information.

The information processing module 21 can be configured to analyze the user information by using artificial intelligence processing to generate or update the user preference information. The artificial intelligence processing can be used to obtain the user preference information corresponding to the plurality of users through machine learning. After a plurality of times of machine learning, the obtained user preference information can become more and more accurate, and the cloud platform can become more and more smart.

The user preference information can include association information between user operations and the current state of the terminal. For example, when the vehicle is driving at a high speed, the user can be in favor of certain music or a certain radio station. When the vehicle is parked, the user can be in favor of certain music, certain news, a certain radio station, or a certain type of video. The user can have a favorite temperature and humidity in the vehicle. The user can have a favorite celebrity, and music, videos, and news related to the celebrity.

In some embodiments, the user preference information can further include personal preference information and similar user preference information. The personal preference information can be the personal preference information of the user. The similar user preference information can be preference information of a certain type of user after big data processing, such as female user preferences, male user preferences, or user preferences of different age groups.

The interface setting module 22 can be configured to set the smart query interface.

When obtaining the user query request, the smart query interface can call the user preference information, query the Internet or the database, and return the query result to the terminal.

The smart query interface can be an integrated interface abstracted from the plurality of resource services. The terminal can only need to call one smart query interface to query and use the plurality of resource services.

In some embodiments, the smart query interface can correspond to the content services, such as news, music, radio, video, etc.

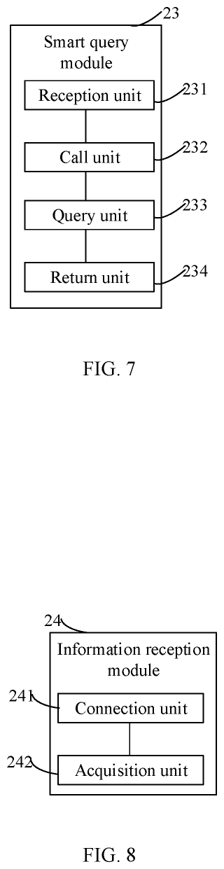

FIG. 7 is a schematic structural diagram of the smart query module 23. The smart query module 23 includes a reception unit 231 configured to obtain the user query request from the terminal for the smart query interface, a call unit 232 configured to call the user preference information, a query unit 233 configured to send the service query request to the Internet to obtain the query information, and a return unit 234 configured to filter and sort the query information according to the user preference information to obtain and return the query result to the terminal.

The reception unit 231 can be configured to obtain the user query request from the terminal. The content of the user query request can include music, news, radio, video, etc. For the variety of user query requests, only one smart query interface needs to be called to perform the query, which simplifies the query process of performing the service query request.

The smart query interface can be configured to send the service query request to the Internet according to the user query request. The Internet can return the query information according to the service query request.

The return unit 234 can be configured to filter and sort the query information according to the user preference information. That is, the content of the returned query information that the user does not like can be removed. The content that the user likes can be sorted. For example, the returned query information can include a variety of songs. The songs of the musicians that the user likes can be sorted in front. The returned query information can include a variety of news, such as current news and entertainment news, etc. The types most frequently browsed by the user can be sorted in front.

In some other embodiments, the query unit can be configured to send the service query request to the database of the platform to obtain the query information.

The smart query module can include a reception unit configured to obtain the user query request from the terminal for the smart query interface, a calling unit configured to call the user preference information, a query unit configured to send the service query request to the database to obtain the query information, and a return unit configured to filter and sort the query information according to the user preference information to obtain and return the query result to the terminal.

The plurality of databases can be included. The query unit can be configured to send the service query request to one of the databases. The database can be the database including the content services, such as news, music, radio, video, etc.

When obtaining the user query request, the smart query interface can first call the user preference information, and then send the service query request to the Internet or the database according to the user query request and the user preference information to obtain and return the query result to the terminal. On one hand, the user service query request can only need to call one smart query interface to perform the query, which simplifies the query process of the terminal performing the service query request. On another hand, when sending the service query request to the Internet or the database, the query result can be optimized according to the user preference information to cause the query result to be more suitable with the user preference.

In some other embodiments, the smart query module can include a reception unit configured to obtain the user query request from the terminal for the smart query interface, a calling unit configured to call the user preference information, a query unit configured to send the service query request to the Internet according to the user query request and the user preference information to obtain the query result, and a return unit configured to return the query result to the terminal.

The smart query interface can send the user query request and the user preference information to the Internet to perform the query. The query result returned by the Internet can be the query result after filtering and sorting.

In some other embodiments, the smart query module can include a reception unit configured to obtain the user query requests from the terminal for the smart query interface, a calling unit configured to call the user preference information, a query unit configured to send the service query request to the database according to the user query request and the user preference information to obtain the query result, and a return unit configured to return the query result to the terminal.

The plurality of databases can be included. The query unit can be configured to send the service query request to one of the databases. The database can be the database including the content services, such as news, music, radio, video, etc.

The smart query interface can send the user query request and the user preference information to the database to perform the query. The query result returned by the Internet can be the query result after filtering and sorting.

When obtaining the user query request, the smart query interface can first call the user preference information, and then send the service query request to the Internet or the database according to the user query request and the user preference information to obtain and return the query result to the terminal. On one hand, the user service query request can only need to call one smart query interface to perform the query, which simplifies the query process of the terminal performing the service query request. On another hand, when sending the service query request to the Internet or the database, the query result can be optimized according to the user preference information to cause the query result to be more suitable with the user preference.

In the server, the information processing module 21 can be configured to generate or update the user preference information. The interface setting module 22 can be configured to set the smart query interface. The smart query module 23 can be configured to, after obtaining the user query request from the terminal, return the query result according to the user preference information generated or updated by the information processing module. When obtaining the user query request, the smart query interface can call the user preference information, query the Internet or the database, and return the query result to the terminal. On one hand, the user service query request can only need to call one smart query interface to perform the query, which simplifies the query process of the terminal performing the service query request. On another hand, when sending the service query request to the Internet or the database, the query result can be optimized according to the user preference information to cause the query result to be more suitable with the user preference.

Correspondingly, embodiments of the present disclosure also provide a storage medium storing computer instructions that, when the computer instructions are executed, cause a computer to perform the processes shown in FIGS. 1 to 4.

Correspondingly, embodiments of the present disclosure also provide a terminal, including a memory and a processor. The memory stores computer instructions that, when executed by the processor, cause the processor to perform the processes shown in FIGS. 1 to 4.

Although the present disclosure is described above, the present disclosure is not limited to this. Those skilled in the art can make various changes and modifications without departing from the spirit and scope of the present disclosure. These changes and modifications are within the scope of the present disclosure. The scope of the present disclosure should be subjected to the scope defined in the claims.

What is claimed is:

1. A user preference data accessing and calling method of a cloud platform comprising:
generating user preference information;
setting an smart query interface;
after the smart query interface receives a user query request from a terminal, returning a query result according to the user preference information.

2. The method of claim 1, wherein generating the user preference information includes:
receiving user information from the terminal; and
analyzing the user information by artificial intelligence processing to generate the user preference information.

3. The method of claim 2, wherein obtaining the user information from the terminal includes:
establishing an upload connection channel with the terminal; and
receiving the user information from the terminal through the upload connection channel.

4. The method of claim 2, wherein analyzing the user information by the artificial intelligence processing to generate the user preference information includes:
analyzing the received user information, to obtain an initial parameter; and
generating the user preference information with the initial parameter.

5. The method of claim 2, wherein analyzing the user information by the artificial intelligence processing to generate the user preference information includes:
analyzing the received user information to obtain an update parameter; and
adding the update parameter to the user preference information that is to be updated to update the user preference information.

6. The method of claim 2, wherein:
the user information includes user operation information, user feedback information, and terminal current state information;
the user operation information includes voice information, voice-to-text information, input text information, or touch information;
the current state information of the terminal includes network environment, application, current position, temperature, humidity, driving status, or speed; and
the user feedback information includes smart interface call information and smart interface call frequency information.

7. The method of claim 6, wherein the user information further includes a user masking identity.

8. The method of claim 2, wherein the user preference information includes association information of a user operation and a current state of the terminal.

9. The method of claim 2, wherein the user preference information includes personal preference information and similar user preference information.

10. The method of claim 1, wherein after the smart query interface recevies the user query request from the terminal, returning the query result according to the user preference information includes:
after the smart query interface receives the user query request from the terminal, sending a service query request to Internet to obtain query information; and
calling the user preference information;
filtering and sorting the query information according to the user preference information; and
returning the query result to the terminal.

11. The method of claim 1, wherein after the smart query interface receives the user query request from the terminal, returning the query result according to the user preference information includes:
after the smart query interface receives the user query request from the terminal, sending a service query request to the database to obtain query information;
calling the user preference information;
filtering and sorting the query information according to the user preference information; and
returning the query result to the terminal.

12. The method of claim 11, wherein a plurality of databases are included, and the smart query interface sends the service query request to one of the databases.

13. The method of claim 1, wherein after the smart query interface receives the user query request from the terminal, returning the query result according to the user preference information includes:
after the smart query interface receives the user query request from the terminal, calling the user preference information; and
sending a service query request to Internet according to the user query request and the user preference information to obtain and return the query result to the terminal.

14. The method of claim 1, after the smart query interface receives the user query request from the terminal, returning the query result according to the user preference information includes:
after the smart query interface receives the user query request from the terminal, calling the user preference information; and
sending a service query request to a database according to the user query request and the user preference information to obtain and return the query result to the terminal.

15. The method of claim 14, wherein:
a plurality of databases are included; and
the smart query interface sends the service query request to one of the databases.

16. The method of claim 2, wherein analyzing the user information by the artificial intelligence processing includes obtaining the user preference information corresponding to a plurality of users by the artificial intelligence processing through machine learning.

17. A user preference data accessing and calling server of a cloud platform comprising:
an information processing module configured to generate user preference information;
an interface setting module configured to set an smart query interface; and
an smart query module configured to, after the smart query interface receives a user query request from a terminal, return a query result according to the user preference information generated by the information processing module.

18. The server of claim 17, further comprising:
an information reception module configured to receive user information from the terminal, wherein:
the information processing module is configured to analyze the user information by artificial intelligence processing to generate the user preference information.

19. The server of claim 18, wherein the information reception module includes:
a connection unit configured to establish an upload connection channel with the terminal; and
an acquisition unit configured to receive the user information from the terminal through the upload connection channel.

20. A non-transitory computer-readable storage medium storing computer instructions that, when executed by a processor, cause the processor to:
generate user preference information;
set an smart query interface;
after the smart query interface receives a user query request from a terminal, return a query result according to the user preference information.
